(19) United States
(12) Patent Application Publication
(10) Pub. No.: US 2019/0341859 A1
(43) Pub. Date: Nov. 7, 2019

(54) ACTIVE CLAMP FLYBACK CONVERTERS

(71) Applicant: TEXAS INSTRUMENTS INCORPORATED, Dallas, TX (US)

(72) Inventor: Isaac COHEN, Dix Hills, NY (US)

(21) Appl. No.: 16/215,930

(22) Filed: Dec. 11, 2018

Related U.S. Application Data
(60) Provisional application No. 62/666,982, filed on May 4, 2018.
(60) Provisional application No. 62/667,161, filed on May 4, 2018.
(60) Provisional application No. 62/696,626, filed on Jul. 11, 2018.

(51) Int. Cl. H02M 7/217; H02M 1/32

(52) U.S. Cl. CPC H02M 7/217; H02M 3/3353; H02M 1/32

(57) ABSTRACT

An active clamp flyback converter includes a transformer, a transistor, a first capacitor, and a second capacitor. The transformer includes a winding. The transistor includes a source terminal that is connected to a first terminal of the winding. The first capacitor includes a first terminal and a second terminal. The first terminal is connected to a drain terminal of the transistor. The second terminal is coupled to a second terminal of the winding. The second capacitor includes a first terminal that is connected to the second terminal of the winding, and is coupled to a second terminal of the first capacitor.

### CROSS-REFERENCE TO RELATED APPLICATIONS

The present application claims priority to U.S. Provisional Patent Application No. 62/666,982 filed May 4, 2018, entitled “Active Clamp Flyback Converter,” U.S. Provisional Patent Application No. 62/667,161 filed May 4, 2018, entitled “Active Clamp Flyback Converter,” and U.S. Provisional Patent Application No. 62/696,626 filed Jul. 11, 2018, entitled “Multimode Active Clamp Flyback Circuit,” each of which is hereby incorporated herein by reference in its entirety.

### BACKGROUND

A switch-mode power supply is an electronic circuit that converts an input direct current (DC) supply voltage into one or more DC output voltages that are higher or lower in magnitude than the input DC supply voltage. A switch-mode power supply that generates an output voltage lower than the input voltage is termed a buck or step-down converter. A switch-mode power supply that generates an output voltage higher than the input voltage is termed a boost or step-up converter.

Some switch-mode power supply topologies include a drive/power transistor coupled at a switch node to an energy storage inductor/transformer. Electrical energy is transferred through the energy storage inductor/transformer to a load by alternately opening and closing the switch as a function of a switching signal. The amount of electrical energy transferred to the load is a function of the ON/OFF duty cycle of the switch and the frequency of the switching signal. Switch-mode power supplies are widely used to power electronic devices, particularly battery powered devices, such as portable, cellular phones, laptop computers, and other electronic systems in which efficient use of power is desirable.

A flyback converter is a type of switch-mode power supply that is commonly used in applications having moderate power requirements. Flyback converters provide input-to-output isolation and can be implemented with relatively few parts, which in-turn reduces the overall cost of the converter.

### SUMMARY

In one example, an active clamp flyback converter includes a transformer, a transistor, a first capacitor, and a second capacitor. The transformer includes a winding. The transistor includes a source terminal that is connected to a first terminal of the winding. The first capacitor includes a first terminal and a second terminal. The first terminal is connected to a drain terminal of the transistor. The second terminal is coupled to a second terminal of the winding. The second capacitor includes a first terminal that is connected to the second terminal of the winding, and is coupled to the second terminal of the first capacitor.

In another example, an active clamp flyback converter includes a transformer, a transistor, a first capacitor, a second capacitor, and a voltage source. The transformer includes a winding. The transistor includes a source terminal that is connected to a first terminal of the winding. The first capacitor includes a first terminal that is connected to a drain terminal of the transistor. The second capacitor includes a first terminal and a second terminal. The first terminal of the second capacitor is connected to ground. The second terminal of the second capacitor is coupled to a second terminal of the first capacitor. The voltage source includes a first terminal and a second terminal. The first terminal of the voltage source is connected to the second terminal of the second capacitor. The second terminal of the voltage source is connected to a second terminal of the winding.

In a further example, a power adapter includes an active clamp flyback converter. The active clamp flyback converter includes a transformer, a rectifier, a power transistor, a clamp transistor, and a control circuit. The transformer includes a primary winding and a secondary winding. The rectifier is connected to the secondary winding. The power transistor is connected to the primary winding. The clamp transistor is connected to the primary winding. The control circuit is coupled to the power transistor and the clamp transistor. The control circuit is configured to turn on the power transistor to induce current flow in the primary winding of the transformer. The control circuit is also configured to, responsive to the power transistor being turned off, turn on the clamp transistor, while the power transistor is turned off, for an interval that is shorter than a time that current flows in the rectifier.

### BRIEF DESCRIPTION OF THE DRAWINGS

For a detailed description of various examples, reference will now be made to the accompanying drawings in which:

FIG. 1 shows a schematic diagram for a flyback converter with a high-side referenced active clamp in accordance with the present disclosure;

FIG. 2 shows signals generated in operation of the flyback converter of FIG. 1 to recycle energy stored in a leakage inductance;

FIG. 3 shows signals generated in operation of the flyback converter of FIG. 1 to recycle energy stored in a leakage inductance and provide zero voltage switching of the power transistor;

FIG. 4 shows a schematic diagram for a flyback converter with a low-side referenced active clamp in accordance with the present disclosure;

FIG. 5 shows signals generated in operation of the flyback converter of FIG. 4 to recycle energy stored in a leakage inductance;

FIG. 6 shows a schematic diagram for a flyback converter with a low-side referenced active clamp that includes a regulated bias supply;

FIG. 7 show a schematic diagram for a circuit for bypassing the offset capacitor of a flyback converter with a high-side referenced active clamp in accordance with the present disclosure;

FIGS. 8A and 8B show a block diagrams of circuits for controlling operation of the clamp transistor in an active clamp flyback circuit in accordance with the present disclosure;

FIG. 9 shows a block diagram for a power adapter that includes an active clamp flyback circuit in accordance with the present disclosure;

FIG. 10 shows a flow diagram for an example method for operating a flyback converter that includes active clamping as disclosed herein;

FIG. 11 shows a flow diagram for an example method for zero-voltage-switching in a flyback converter that includes active clamping as disclosed herein.

### DETAILED DESCRIPTION

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” The recitation “based on” is intended to mean “based at least in part on.” Therefore, if X is based on Y, X may be a function of Y and any number of other factors.

A flyback converter includes a transformer and a power transistor that is turned on store energy in the transformer, and turned off to transfer the stored energy to the secondary of the transformer. When the power transistor is turned off, the leakage inductance of the transformer primary winding causes a high voltage transient on the drain of the power transistor, which may stress the power transistor. To dissipate the energy stored in leakage inductance, and reduce the stress on the power transistor, a clamp circuit may be added to the flyback converter.

The clamp circuit may be active or passive. A passive clamp circuit may be implemented with diodes and is relatively inexpensive. Because the passive clamp circuit dissipates the energy stored in the leakage inductance as heat, the passive clamp circuit limits the overall efficiency of the converter. An active clamp circuit provides improved efficiency relative to the passive clamp circuit. The active clamp circuit replaces the diodes of the passive clamp circuit with a transistor and a capacitor. In the active clamp circuit, the transistor transfers the energy stored in leakage inductance of the transformer primary winding to the capacitor. The energy stored in capacitor is returned to the primary winding.

The active clamping circuit may be further improved by adding an offset voltage to the clamp capacitor by including an offset capacitor between the clamp capacitor and a power rail (e.g., ground or the voltage rail powering the converter). The clamp offset capacitor controls the transfer of energy from the primary winding to the secondary winding of the transformer, and in the process, absorbs the energy stored in the leakage inductance.

The active clamp flyback converters disclosed herein connect the voltage source powering the converter in series with the offset capacitor and the transformer primary. As a result, the energy stored in the offset capacitor is extracted during conduction of the power transistor and delivered to the secondary winding, thereby improving converter efficiency. The active clamp flyback converters of the present disclosure also provide zero voltage switching by activating the clamp transistor twice during an operation cycle. The first activation transfers the energy stored in the leakage inductance to the clamp capacitor and the offset capacitor. The second activation uses the charge on the clamp capacitor to induce reverse current flow in the transformer primary and bring the voltage across the power transistor to zero.

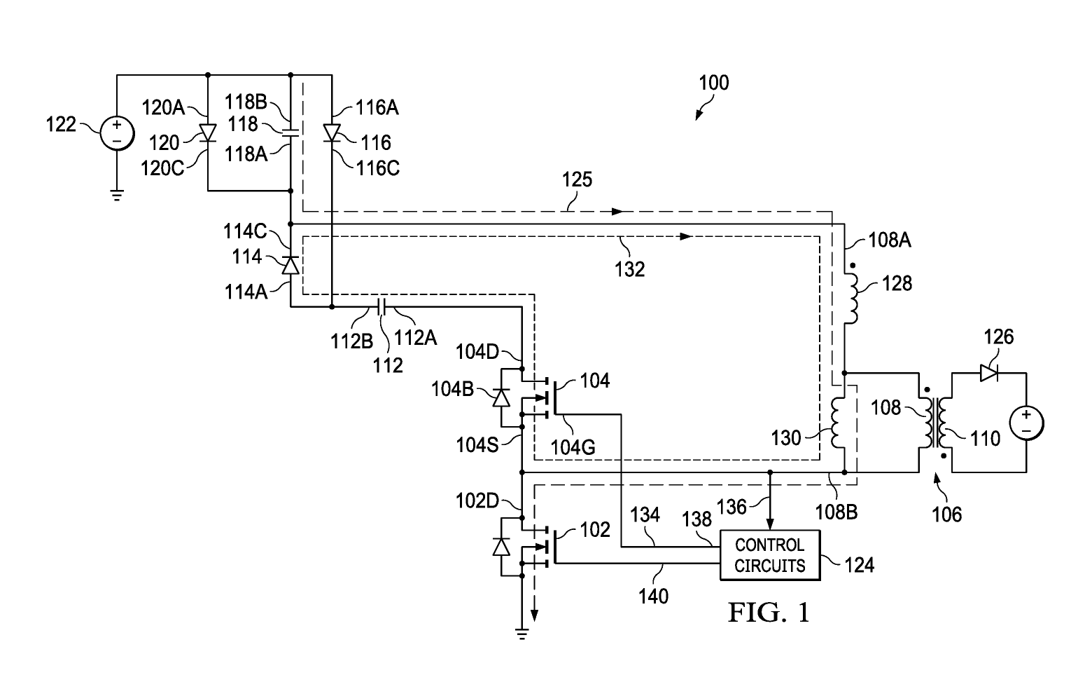

FIG. 1 shows a schematic diagram for a flyback converter 100 with a high-side referenced active clamp in accordance with the present disclosure. The flyback converter 100 includes a power transistor 102, a clamp transistor 104, a transformer 106, a clamp capacitor 112, a diode 114, a diode 116, an offset capacitor 118, and a control circuit 124. Some implementations of the flyback converter 100 include a diode 120. The transformer 106 includes a primary winding 108 and a secondary winding 110. The primary winding 108 includes a leakage inductance 128 and a magnetizing inductance 130. The control circuit 124 controls the power transistor 102 and the clamp transistor 104. The control circuit 124 includes pulse generation circuitry that produces the pulses that control the power transistor 102 and the clamp transistor 104. The power transistor 102 and the clamp transistor 104 may be negative channel (N-channel) metal oxide semiconductor field effect transistors (MOSFETs) in some implementations of the flyback converter 100.

The drain terminal 102D of the power transistor 102 is connected to the source terminal 104S of the clamp transistor 104 and to a terminal 108B of the primary winding 108. The drain terminal 104D of the clamp transistor 104 is connected to a first terminal 112A of the clamp capacitor 112. A second terminal 112B of the clamp capacitor 112 is connected to the anode 114A of the diode 114 and to the cathode 116C of the diode 116. The cathode 114C of the diode 114 is connected to a first terminal 118A of the offset capacitor 118, and to a terminal 108A of the primary winding 108. The second terminal 118B of the offset capacitor 118 is connected to the anode terminal 116A of the diode 116 and to the voltage source 122. The voltage source 122 may be, for example, a rectifier coupled to an alternating current power source. If the flyback converter 100 includes the diode 120, then the anode terminal 120A of the diode 120 is connected to the terminal 1186 of the offset capacitor 118, and the cathode terminal 120C of the diode 120 is connected to the terminal 118A of the offset capacitor 118.

Pulses generated by the control circuit 124 turn on the power transistor 102 to induce current flow in the primary winding 108 and charge (i.e., generate a magnetic field in) the transformer 106. Turning on the power transistor 102 causes current 125 to flow from the voltage source 122 through the offset capacitor 118 and/or the diode 120, the primary winding 108, and the power transistor 102. The control circuit 124 turns off the power transistor 102 when the current 125 flowing in the power transistor 102 reaches a predetermined value or the power transistor 102 has been turned on for a predetermined time. When the power transistor 102 is turned off, the magnetic field generated by the current 125 collapses and current flows in the secondary winding 110, through the rectifier 126 to a capacitor and a load circuit.

After the control circuit 124 turns off the power transistor 102, the voltage on the source terminal 104S of the clamp transistor 104 increases. When the voltage at the source terminal 104S of the clamp transistor 104 exceeds the voltage at the drain terminal 104D of the clamp transistor 104, current 132 flows through the primary winding 108, the body diode 104B of the clamp transistor 104, the clamp capacitor 112 and the diode 114 to transfer the energy stored in the leakage inductance 128 to the clamp capacitor 112, and then to the offset capacitor 118. The control circuit 124 includes an output terminal 138 that is coupled to a gate terminal 104G of the clamp transistor 104. The control circuit 124 activates a signal 134 at the output terminal 138 to turn on the clamp transistor 104 after the current 132 starts to flow. The control circuit 124 may turn on the clamp transistor 104 for a relatively short time (e.g., an interval sufficient to transfer the energy stored in the leakage inductance 128 to the clamp capacitor 112 and the offset capacitor 118). For example, the control circuit 124 turns on the clamp transistor 104 for an interval starting at the point in time when the power transistor 102 is turned off. The interval may be at least if ¼ the resonant period of the leakage inductance 128 and the capacitance of the clamp capacitor 112 plus ½ the resonant period of the leakage inductance 128 and the capacitance of the clamp capacitor 112 in series with the capacitance of the offset capacitor 118, but no longer than the time that current is flowing in the rectifier 126.

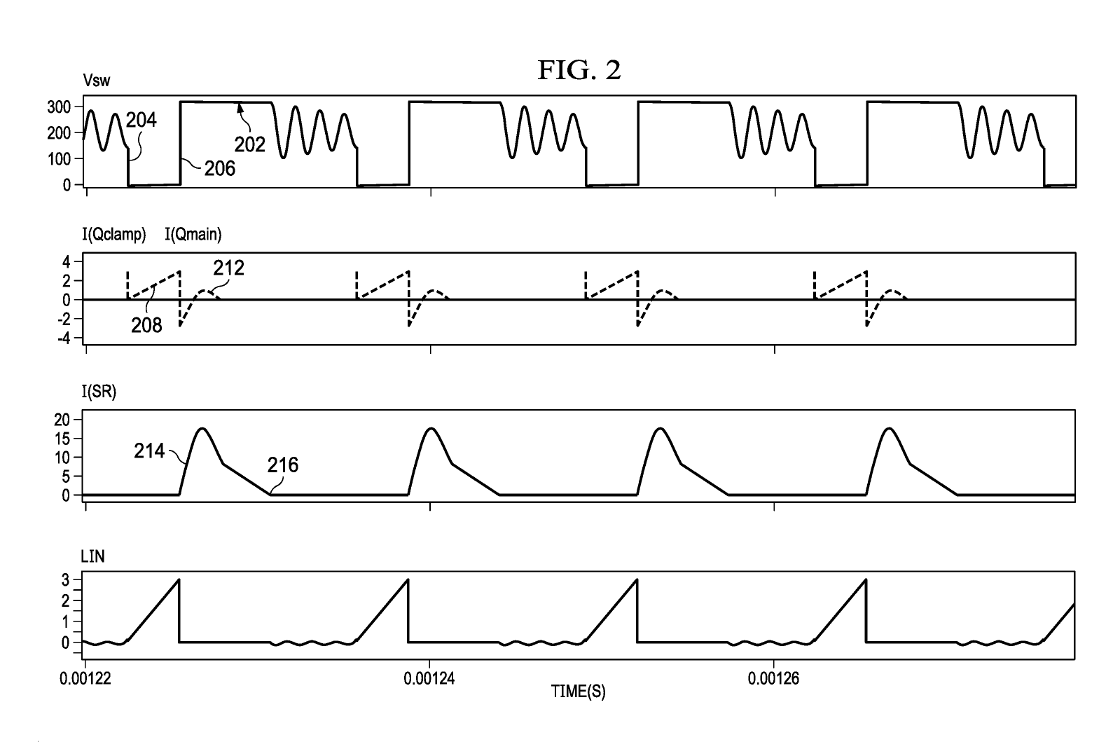

After the control circuit 124 turns off the clamp transistor 104, when the control circuit 124 next turns on the power transistor 102, the energy stored on the offset capacitor 118 is transferred to the primary winding 108. Thus, in the flyback converter 100, energy stored in the leakage inductance 128 in one cycle is transferred back to the primary winding 108 in the next cycle to improve the efficiency of the flyback converter 100. FIG. 2 shows signals in the flyback converter 100 when the clamp transistor 104 is turned on to discharge the leakage inductance 128. The power transistor 102 is turned on at time 204, the voltage 202 at the drain of the power transistor 102 is pulled to ground, and the current 208 in the magnetizing inductance 130 increases. At time 206, the power transistor 102 is turned off, current 212 flows from the leakage inductance 128 through the clamp transistor 104 (i.e., through the body diode 104B of the clamp transistor 104 and the drain-source channel of the clamp transistor 104 to the clamp capacitor 112 and the offset capacitor 118. Current 214 flows in the secondary winding 110 and through the rectifier 126 until the 108 is discharged at time 216.

Implementations of the flyback converter 100 may also provide zero voltage switching. In such implementations after the control circuit 124 turns on the clamp transistor 104 a first time to transfer the energy stored in the leakage inductance 128 to the clamp capacitor 112 and the offset capacitor 118, the control circuit 124 may turn on the clamp transistor 104 a second time (i.e., for a second interval) prior to turning on the power transistor 102. When the clamp transistor 104 is turned on the second time, voltage on the clamp capacitor 112 causes current to flow from the clamp capacitor 112 through the clamp transistor 104 and the primary winding 108. When the clamp transistor 104 is turned off, current continues to flow in the primary winding 108 and discharge the drain capacitance of the power transistor 102. When the voltage at the drain terminal 102D falls to zero, the power transistor 102 may be turned on with no switching loss.

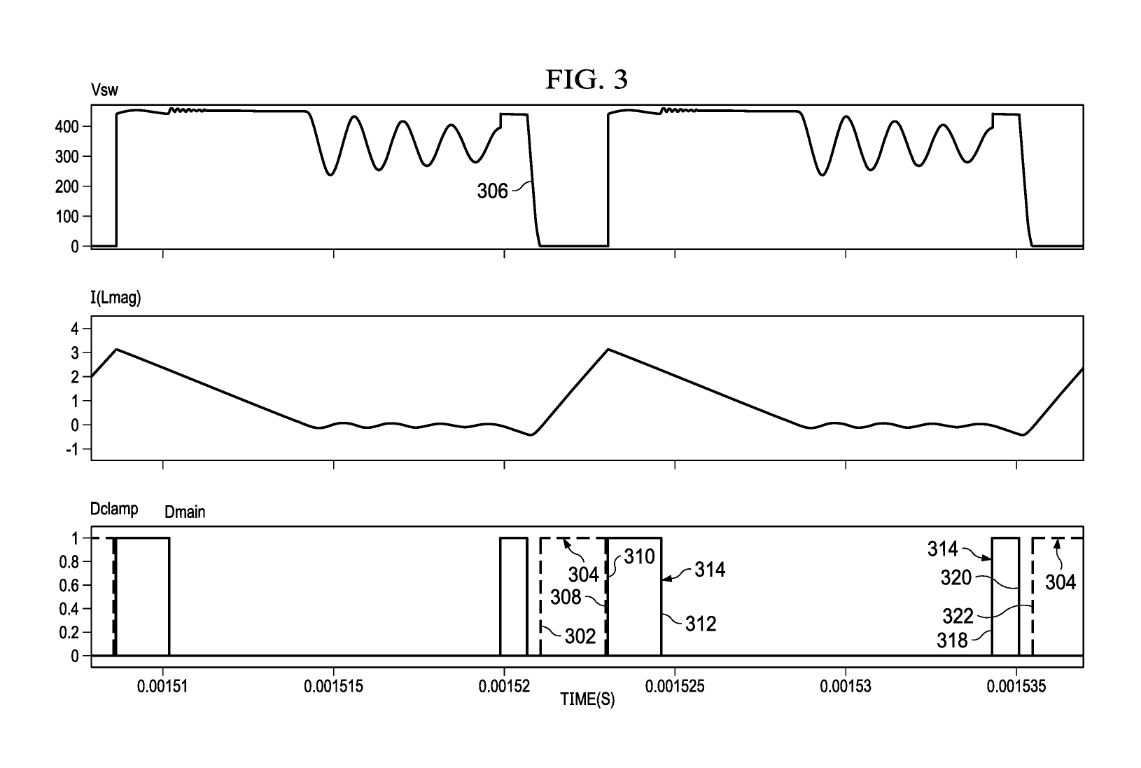

FIG. 3 shows signals in the flyback converter 100 when operating with zero voltage switching. At time 302, the control circuit 124 activates signal 304 to turn on the power transistor 102. The signal 304 is the same as the signal 104 shown in FIG. 1. In response, the power transistor 102 pulls the voltage 306 at the drain of the power transistor 102 to ground and current in the magnetizing inductance 130 increases. At time 308, the control circuit 124 deactivates the signal 304 to turn off the power transistor 102, the voltage 306 increases and current flows from the leakage inductance 128 through the body diode 1046 of the clamp transistor 104 to the clamp capacitor 112 and the offset capacitor 118. At time 310, the control circuit 124 activates the signal 314 to turn on the clamp transistor 104. The signal 314 is the same as the signal 134 shown in FIG. 1. When the energy stored in the leakage inductance 128 has been transferred to the clamp capacitor 112 and the offset capacitor 118, the control circuit 124 deactivates the signal 314 at time 312. At time 318, the control circuit 124 reactivates the signal 314 and current flows from the clamp capacitor 112 through the clamp transistor 104 to the primary winding 108. At time 320, the control circuit 124 deactivates the signal 314 to turn off the clamp transistor 104. When the clamp transistor 104 is turned off, current continues to flow in the primary winding 108, and the capacitance associated with the drain terminal 102D is discharged. When the voltage at the drain terminal 102D falls to zero, the control circuit 124 activates the signal 304 at time 322 to turn on the power transistor 102 and charge the primary winding 108.

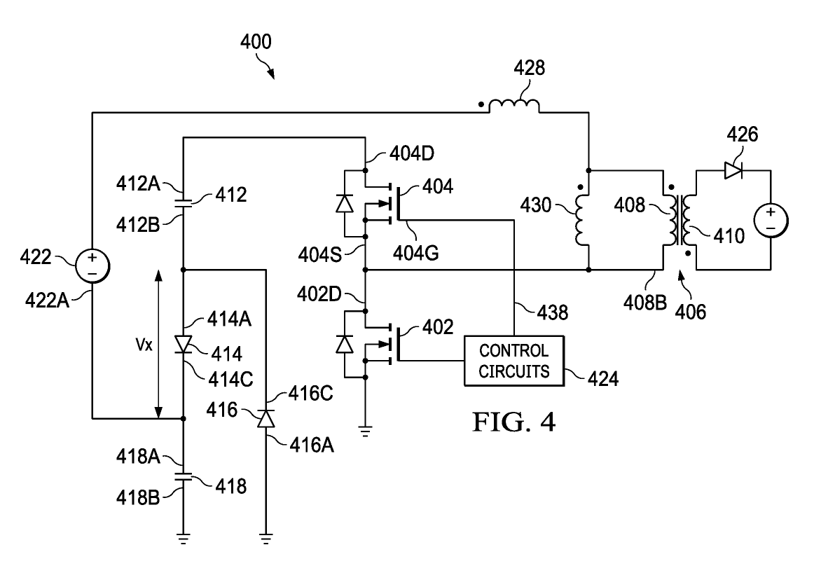

FIG. 4 shows a schematic diagram for a flyback converter 400 with a low-side referenced active clamp in accordance with the present disclosure. The flyback converter 400 includes a power transistor 402, a clamp transistor 404, a transformer 406, a clamp capacitor 412, a diode 414, a diode 416, an offset capacitor 418, and a control circuit 424. The transformer 406 includes a primary winding 408 and a secondary winding 410. The primary winding 408 includes a leakage inductance 428 and a magnetizing inductance 430. The control circuit 424 controls the power transistor 402 and the clamp transistor 404. The control circuit 424 includes pulse generation circuitry that produces the pulses that control the power transistor 402 and the clamp transistor 404. The power transistor 402 and the clamp transistor 404 may be N-channel MOSFETs in some implementations of the flyback converter 400.

The drain terminal 402D of the power transistor 402 is connected to the source terminal 404S of the clamp transistor 404 and to a terminal 408B of the primary winding 408. The drain terminal 404D of the clamp transistor 404 is connected to a first terminal 412A of the clamp capacitor 412. A second terminal 412B of the clamp capacitor 412 is connected to the anode 414A of the diode 414 and to the cathode 416C of the diode 416. The anode 416A of the diode 416 is connected to ground. The cathode 414C of the diode 414 is connected to a first terminal 418A of the offset capacitor 418, and to a terminal 422A of the voltage source 422. The second terminal 418B of the offset capacitor 418 is connected to ground. The voltage source 422 may be, for example, a direct current output power source.

Pulses generated by the control circuit 424 turn on the power transistor 402 to induce current flow in the primary winding 408 and charge the transformer 406. Turning on the power transistor 402 causes current to flow from the voltage source 422 through the primary winding 408 and the power transistor 402. The control circuit 424 turns off the power transistor 402 when the current flowing in the power transistor 402 reaches a predetermined value or the power transistor 402 has been turned on for a predetermined time. When the power transistor 402 is turned off, the magnetic field about the transformer 406 collapses and current flows in the secondary winding 410, through the rectifier 426 to a capacitor and a load circuit.

After the control circuit 424 turns off the power transistor 402, the voltage on the source of the clamp transistor 404 increases. When the voltage at the source of the clamp transistor 404 exceeds the voltage at the drain of the clamp transistor 404, current flows through the primary winding 408, the body diode 404B of the clamp transistor 404, the clamp capacitor 412 and the diode 414 to transfer the energy stored in the leakage inductance 428 to the clamp capacitor 412, and to the offset capacitor 418. The control circuit 424 may turn on the clamp transistor 404 after current is flowing in the body diode 404B. The control circuit 424 includes an output terminal 438 that is coupled to a gate terminal 404G of the clamp transistor 404. The control circuit 424 activates a signal 434 at the output terminal 438 to turn on the clamp transistor 404. The control circuit 424 may turn on the clamp transistor 404 for a relatively short time (e.g., an interval sufficient to transfer the energy stored in the leakage inductance 428 to the clamp capacitor 412 and the offset capacitor 418). For example, the control circuit 424 turns on the clamp transistor 404 for an interval starting at the point in time when the power transistor 402 is turned off. The interval may be at least as long as ¼ the resonant period of the leakage inductance 428 and the capacitance of the clamp capacitor 412 plus ½ the resonant period of the leakage inductance 428 and the capacitance of the clamp capacitor 412 in series with the capacitance of the offset capacitor 418 but no longer than the time that current is flowing in the rectifier 426.

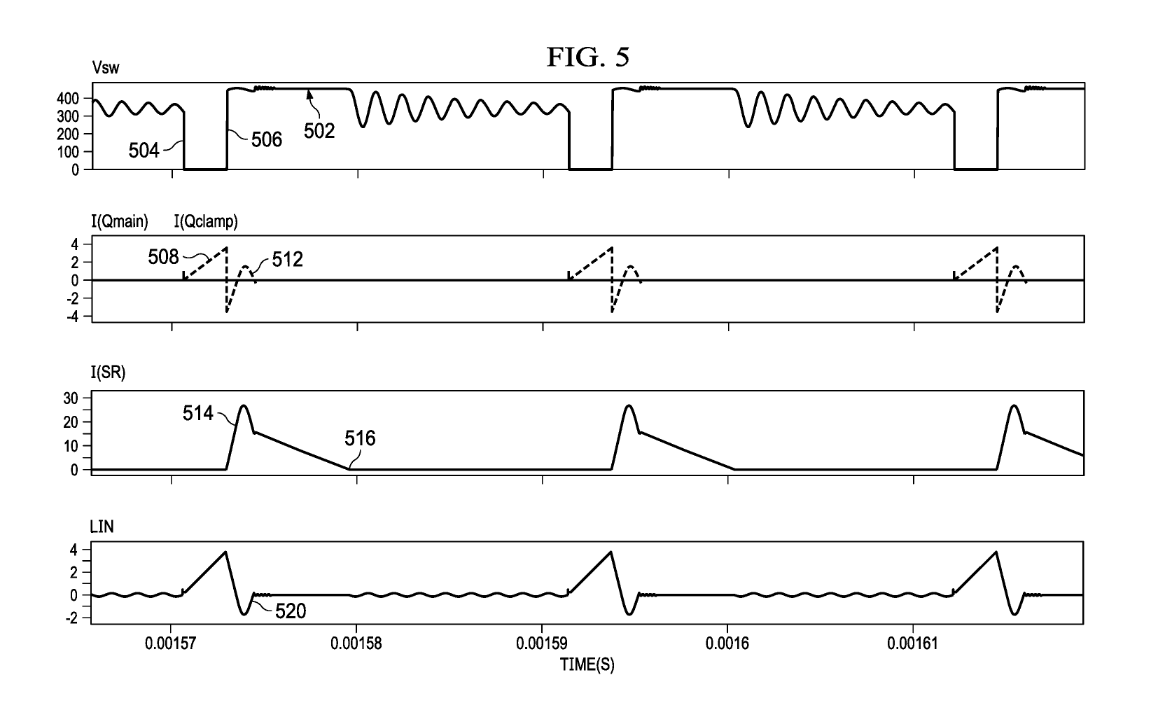

After the control circuit 424 turns off the clamp transistor 404, when the control circuit 424 next turns on the power transistor 402, the energy stored on the offset capacitor 418 is transferred to the primary winding 408, via the voltage source 422. Thus, in the flyback converter 400, energy stored in the leakage inductance 428 in one cycle is transferred back to the primary winding 408 in the next cycle to improve the efficiency of the flyback converter 400. FIG. 5 shows signals in the flyback converter 400 when the clamp transistor 404 is turned on to discharge the leakage inductance 428. The power transistor 402 is turned on at time 504, the voltage 502 at the drain of the power transistor 402 is pulled to ground, and the current 508 in the magnetizing inductance 430 increases. At time 506, the power transistor 402 is turned off, current 512 flows from the leakage inductance 428 through the clamp transistor 404 (i.e., through the body diode 404B of the clamp transistor 404 and the drain-source channel of the clamp transistor 404) to the clamp capacitor 412 and the offset capacitor 418. Current 514 flows in the secondary winding 410 and through the rectifier 426 until time 516. Negative current 520 flows in the magnetizing inductance 430 as a result of unnecessary energy circulation associated with the low side clamp circuitry. The high-side clamp circuitry of the flyback converter 100 avoids negative current flow.

Implementations of the flyback converter 400 may also provide zero voltage switching. In such implementations, after the control circuit 424 turns on the clamp transistor 404 a first time to transfer the energy stored in the leakage inductance 428 to the clamp capacitor 412 and the offset capacitor 418, the control circuit 424 may turn on the clamp transistor 404 a second time (i.e., for a second interval) prior to turning on the power transistor 402. When the clamp transistor 404 is turned on the second time, voltage on the clamp capacitor 412 causes current to flow from the clamp capacitor 412 through the clamp transistor 404 and the primary winding 408. When the clamp transistor 404 is turned off, current continues to flow in the primary winding 408 and discharge the drain capacitance of the power transistor 402. When the voltage at the drain terminal 402D falls to zero, the power transistor 402 is may be turned on with no switching loss.

Thus, the active clamp flyback converters 100 and 400 provide a number of advantages over other flyback converter implementations. Converter efficiency is improved by recycling energy stored in the leakage inductance of the flyback transformer, and by enabling implementation of zero voltage switching. Because energy recycling and zero voltage switching are decoupled, the flyback converters may operate in a relatively narrow frequency range, which increases the range of applications in which the converters can be used, and supports multimode operation. For example, implementations of the flyback converters 100 and 400 may operate in continuous conduction mode, discontinuous conduction mode, transition mode, constant frequency mode, burst mode, etc., which allows improved efficiency with line and load variation. Because active clamping is enabled over a very short interval after deactivation of the power transistor, the active clamp converters 100 and 400 are able to provide active clamping at low operational frequencies that may require passive clamping in other implementations.

At least some of the circuitry of the flyback converter 100 and the flyback converter 400 may be implemented as an integrated circuit. For example, the control circuits 124, the power transistor 102, the clamp transistor 104, the clamp capacitor 112, the diode 114, the diode 116, the diode 120, and/or the offset capacitor 118 may be included in an integrated circuit. Similarly, the control circuits 424, the power transistor 402, the clamp transistor 404, the clamp capacitor 412, the diode 414, the diode 416, and/or the offset capacitor 418 may be included in an integrated circuit.

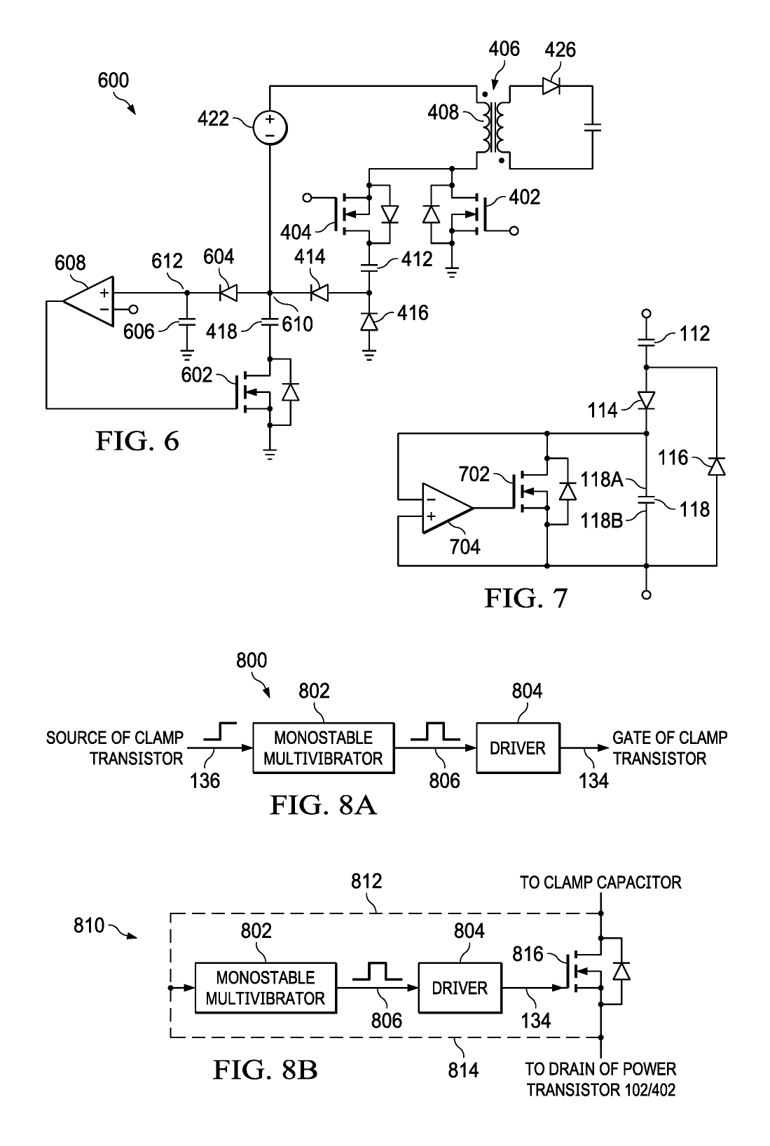

FIG. 6 shows a schematic diagram for a flyback converter 600 with a low-side referenced active clamp that includes a regulated bias supply. The flyback converter 600 is an implementation of the flyback converter 400. The flyback converter 600 includes the power transistor 402, the clamp transistor 404, the transformer 406, the clamp capacitor 412, the diode 414, the diode 416, and the offset capacitor 418 as shown in FIG. 4. The flyback converter 600 also includes a bias transistor 602, a diode 604, a bias capacitor 606, and a hysteretic comparator 608.

The voltage at node 610 (i.e., the clamp offset voltage) is a function of the capacitance of the offset capacitor 418 and load driven by the flyback converter 600. If the load is light, the clamp offset voltage may drop below the minimum required for the bias voltage The hysteretic comparator 608 monitors the voltage at the node 612 (i.e., the bias voltage across the bias capacitor 606). If the bias voltage drops below a predetermined minimum voltage (V_LOW), then the hysteretic comparator 608 turns off the bias transistor 602 and energy is transferred from the primary winding 408 to the bias capacitor 606 rather than recycled. As the bias voltage increases to exceed a predetermined maximum voltage (V_HIGH), the hysteretic comparator 608 turns on the bias transistor 602 and recycling of energy is resumed.

FIG. 7 show a schematic diagram for a circuit 700 for bypassing the offset capacitor of the flyback converter 100. In the circuit 700, the transistor 702 replaces the diode 120 shown in FIG. 1. A comparator 704 is coupled to the gate terminal of the transistor 702 to control the transistor 702. The comparator 704 turns on the transistor 702 when the voltage at terminal 1186 of the offset capacitor 118 is greater than the voltage at the terminal 118A of the offset capacitor 118, and turns off the transistor 702 when the voltage at terminal 118B of the offset capacitor 118 is less than the voltage at the terminal 118A of the offset capacitor 118. The transistor 702 reduces conduction loss, relative to the diode 120, or the diode 116 in series with the diode 114, in the flyback converter 100.

FIG. 8A shows a block diagram for a circuit 800 for controlling operation of the clamp transistor in an active clamp flyback circuit in accordance with the present disclosure. The circuit 800 may be included in the implementations of the control circuit 124 or the control circuit 424. Operation of the circuit 800 is explained with regard to the flyback converter 100, and operation with the flyback converter 400 is similar. The circuit 800 includes a monostable multivibrator 802 and a transistor driver 804. The monostable multivibrator 802 is triggered by a rise in voltage at the source terminal 104S of the clamp transistor 104. That is, when the power transistor 102 is turned off, and the voltage at the source terminal 104S of the clamp transistor 104 rises, the monostable multivibrator 802 is triggered to generate a pulse 806. The pulse 806 may be at least as long as ¼ the resonant period of the leakage inductance 128 and the capacitance of the clamp capacitor 112 plus ½ the resonant period of the leakage inductance 128 and the capacitance of the clamp capacitor 112 in series with the capacitance of the offset capacitor 118, but no longer than the time that current is flowing in the secondary winding 110 while the power transistor 102 is turned off. The monostable multivibrator 802 is coupled to the transistor driver 804. The transistor driver 804 may level shift the pulse 806 and provide sufficient current to drive the gate capacitance of the clamp transistor 104.

FIG. 8B shows a block diagram for an active clamp flyback circuit 810 in accordance with the present disclosure. The active clamp flyback circuit 810 is similar to the circuit 800 and includes a clamp transistor 816. The clamp transistor 816 is an implementation of the clamp transistor 102 or the clamp transistor 402. Examples of the active clamp flyback circuit 810 may be implemented in an integrated circuit. The circuit 810 may be included in the implementations of the control circuit 124 or the control circuit 424. The gate terminal of the clamp transistor is coupled to the transistor driver 804. The monostable multivibrator 802 may be coupled to the source or the drain of the clamp transistor 816 to detect voltage change caused by deactivation of the power transistor 102. Accordingly, the monostable multivibrator 802 generates the pulse 806 responsive to the signal 812 or the signal 814 generated by deactivation of the power transistor 102, and the transistor driver 804 activates the clamp transistor 816 for the time that the pulse 806 is active.

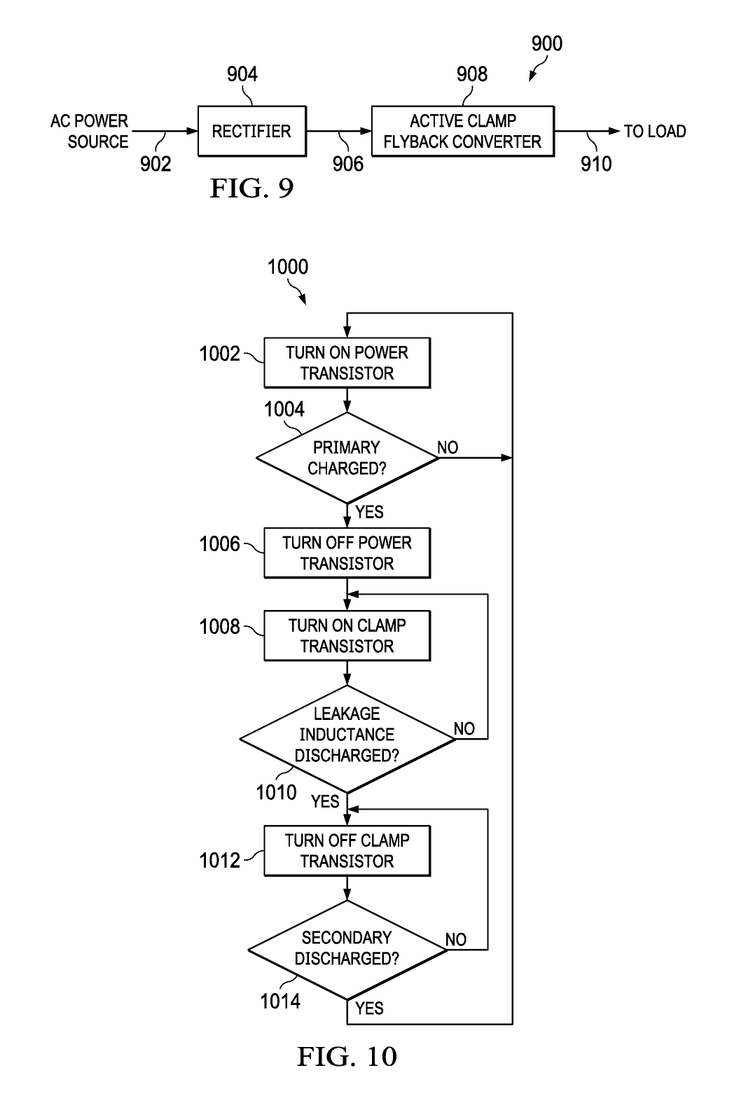

FIG. 9 shows a block diagram for a power adapter 900 in accordance with the present disclosure. The 900 includes a rectifier 904 and an active clamp flyback converter 908. The 908 may be an implementation of the flyback converter 100 or the flyback converter 400. The 902 is configured to receive an alternating current (AC) power signal 902, and convert the AC signal to a DC power signal 906. The 902 may be a diode or transistor based rectifier, such as a diode or transistor bridge, with a storage capacitor to smooth the bridge output. The 908 generates a DC output voltage 910 from the 906. The 908 may a higher voltage or a lower voltage than the 906. The 910 may be provided to a load circuit, such as a smartphone, a tablet computer, a notebook computer, or other electronic device to power the device or to charge an internal battery of the device. The 908 may be highly efficient due the recycling of energy stored in leakage inductance 128 of the primary winding 108 and implementation of zero voltage switching as disclosed herein. As a result, the physical size of the 900 may be reduced relative to power adapters that apply less efficient implementations of a flyback converter.

FIG. 10 shows a flow diagram for an example method 1000 for operating a flyback converter that includes active clamping as disclosed herein. Though depicted sequentially as a matter of convenience, at least some of the actions shown can be performed in a different order and/or performed in parallel. Additionally, some implementations may perform only some of the actions shown. While the method 1000 is explained with reference to the flyback converter 100, the method 1000 is also applicable to the flyback converter 400. Operations of the method 1000 may be implemented by the control circuit 124 or the control circuit 424.

In block 1002, the control circuit 124 activates the control signal 140, which turns on the power transistor 102 to charge the primary winding 108.

If, in block 1004, the control circuit 124 determines that charging of primary winding 108 is complete (i.e., a predetermined current is flowing in the primary winding 108), then the control circuit 124 deactivates the control signal 140, which turns off the power transistor 102 in block 1006.

After turning off the power transistor 102, in block 1008, the control circuit 124 turns on the clamp transistor 104 to transfer energy stored in the leakage inductance 128 to the clamp capacitor 112 and the offset capacitor 118. The clamp transistor 104 will remain turned on for a relatively short time, e.g., long enough to discharge the leakage inductance 128 and much less than the time that the power transistor 102 is turned off.

In block 1010, the control circuit 124 determines whether the leakage inductance 128 has been discharged. In some implementations, the time to discharge the leakage inductance is predetermined. That is, the time interval during which the clamp transistor 104 is turned on may be fixed.

If the leakage inductance has been discharged, then in block 1012, the control circuit 124 turns off the clamp transistor 104.

In block 1014, the control circuit 124 determines whether the power transistor 102 is to be turned on. For example, the control circuit 124 may determine whether the secondary winding 110 has been discharged, secondary side voltage has dropped below a threshold, etc.

Responsive to determining that the power transistor 102 is to be turned on in block 1014, the control circuit 124 turns on the power transistor 102 in block 1002.

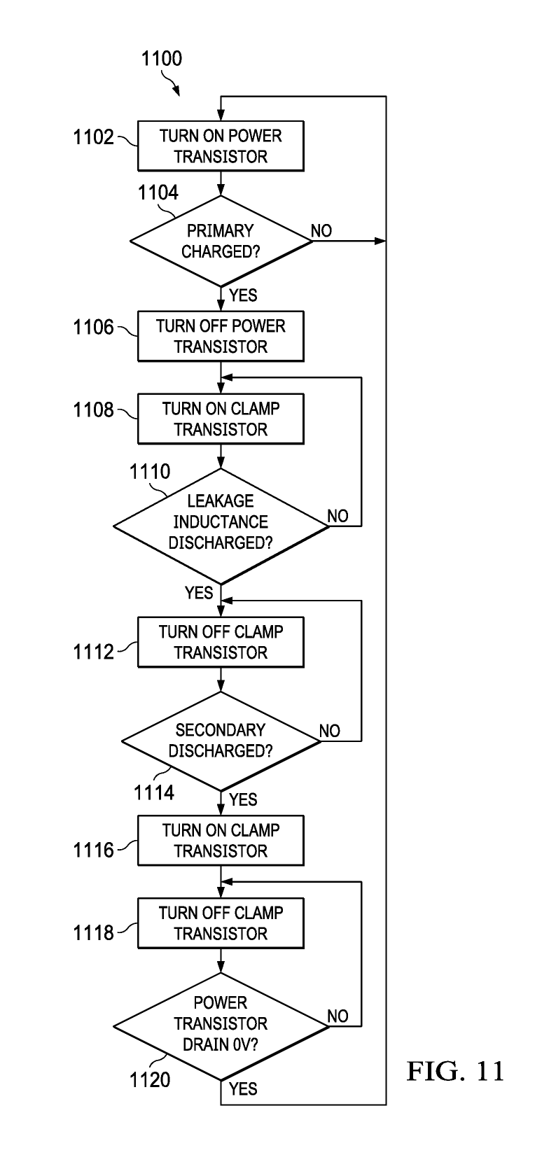

FIG. 11 shows a flow diagram for an example method 1100 for zero-voltage-switching in a flyback converter that includes active clamping as disclosed herein. Though depicted sequentially as a matter of convenience, at least some of the actions shown can be performed in a different order and/or performed in parallel. Additionally, some implementations may perform only some of the actions shown. While the method 1100 is explained with reference to the flyback converter 100, the method 1100 is also applicable to the flyback converter 400. Operations of the method 1100 may be implemented by the control circuit 124 or the control circuit 424.

In block 1102, the control circuit 124 activates the control signal 140, which turns on the power transistor 102 to charge the primary winding 108.

If, in block 1104, the control circuit 124 determines that charging of primary winding 108 is complete (i.e., a predetermined current is flowing in the primary winding 108), then the control circuit 124 deactivates the control signal 140, which turns off the power transistor 102 in block 1106.

After turning off the power transistor 102, in block 1108, the control circuit 124 turns on the clamp transistor 104 to transfer energy stored in the leakage inductance 128 to the clamp capacitor 112 and the offset capacitor 118. The clamp transistor 104 will remain turned on for a relatively short time, long enough to discharge the leakage inductance 128 and much less than the time that the power transistor 102 is turned off.

In block 1110, the control circuit 124 determines whether the leakage inductance 128 has been discharged. In some implementations, the time to discharge the leakage inductance is predetermined. That is, the time interval during which the clamp transistor 104 is turned on may be fixed.

If the leakage inductance has been discharged, then in block 1112, the control circuit 124 turns off the clamp transistor 104.

In block 1114, the control circuit 124 determines whether the power transistor 102 is to be turned on. For example, the control circuit 124 may determine whether the secondary winding 110 has been discharged, secondary side voltage has dropped below a threshold, etc.

Responsive to determining that the power transistor 102 is to be turned on in block 1114, to enable zero voltage switching the control circuit 124 turns on the clamp transistor 104 in block 1116. With the clamp transistor 102 on, current flows from the clamp capacitor 112 through the clamp transistor 104 to the primary winding 108.

In block 1118, the control circuit 124 turns off the clamp transistor 104. When the clamp transistor 104 is turned off, current continues to flow in the primary winding 108, and the capacitance associated with the drain terminal 102D of the power transistor 102 is discharged.

In block 1120, the control circuit 120 determines whether the voltage at the drain terminal 102D of the power transistor 102 has fallen to zero. When the voltage at the drain terminal 102D has fallen to zero, the control circuit 124 turns on the power transistor 102 to charge the primary winding 108.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An active clamp flyback converter, comprising:
a transformer having a winding, the winding having a first terminal and a second terminal;
a transistor having a gate terminal, having a drain terminal, and having a source terminal connected to the first terminal of the winding;
a first capacitor, having:
a first terminal connected to the drain terminal of the transistor; and
a second terminal coupled to the second terminal of the winding; and
a second capacitor, having a first terminal connected to between the second terminal of the winding, and the second terminal of the first capacitor, and having a second terminal.

2. The active clamp flyback converter of claim 1, including a diode having:
an anode connected to the second terminal of the first capacitor; and
a cathode connected to the first terminal of the second capacitor.

3. The active clamp flyback converter of claim 1, including a diode having:
an anode connected to the second terminal of the second capacitor; and
a cathode connected to the first terminal of the second capacitor.

4. The active clamp flyback converter of claim 1, including a diode having:
an anode connected to the second terminal of the second capacitor; and
a cathode connected to the second terminal of the first capacitor.

5. The active clamp flyback converter of claim 1, in which the transistor is a first transistor, and the active clamp flyback converter includes a second transistor having a drain connected to the source of the first transistor.

6. The active clamp flyback circuit of claim 5, including a control circuit having an output terminal coupled to the gate terminal of the first transistor; the control circuit is configured to activate a signal at the output for a predetermined time after the second transistor is turned off.

7. The active clamp flyback circuit of claim 6, in which the control circuit is configured to:
deactivate the signal after expiration of the predetermined time; and
reactivate the signal for a predefined time prior to turning on the second transistor.

8. An active clamp flyback converter, comprising:
a transformer having a winding, the winding having a first terminal and a second terminal;
a transistor having a gate terminal, having a drain terminal, and having a source terminal connected to a first terminal of the winding;
a first capacitor, having a first terminal connected to the drain terminal of the transistor, and having a second terminal;
a second capacitor, having a first terminal connected to ground, and a second terminal coupled to the second terminal of the first capacitor;
a voltage source, having a first terminal connected to between the second terminal of the first capacitor and the second terminal of the second capacitor, and a second terminal connected to the second terminal of the winding.

9. The active clamp flyback converter of claim 8, including a diode having:
an anode connected to the second terminal of the first capacitor; and
a cathode connected to the second terminal of the second capacitor.

10. The active clamp flyback converter of claim 8, including a diode having:
an anode connected to ground; and
a cathode connected to the second terminal of the first capacitor.

11. The active clamp flyback converter of claim 8, in which the transistor is a first transistor, and the active clamp flyback converter includes a second transistor having a gate terminal, having a source terminal, and having a drain terminal connected to the source terminal of the first transistor.

12. The active clamp flyback circuit of claim 11, including a control circuit having an output terminal coupled to the gate terminal of the first transistor; the control circuit is configured to activate a signal at the output terminal for a predetermined time after the second transistor is turned off.

13. The active clamp flyback circuit of claim 12, in which the control circuit is configured to:
deactivate the signal at the after expiration of the predetermined time; and
reactivate the signal for a predefined time prior to turning on the second transistor.

14. The active clamp flyback circuit of claim 11, in which the control circuit is configured to activate the signal responsive to detection of an increase in voltage at the source terminal of the first transistor.

15. A power adapter, comprising:
a transformer having a primary winding, and a secondary winding;
a rectifier connected to the secondary winding;
a power transistor connected to the primary winding, the power transistor having a gate terminal, having a drain terminal, and having a source terminal;
a clamp transistor connected to the primary winding, the clamp transistor having a gate terminal, having a drain terminal, and having a source terminal; and
a control circuit coupled to the power transistor and the clamp transistor, the control circuit configured to:
turn on the power transistor to induce current flow in the primary winding of the transformer;
responsive to the power transistor being turned off, turn on the clamp transistor for a first interval that is shorter than a time that current flows in the rectifier while the power transistor is turned off;
turn off the clamp transistor at expiration of the first interval;
turn on the clamp transistor for a second interval that starts after expiration of the first interval and ends prior to voltage at a source of the clamp transistor falling to zero; and
turn off the clamp transistor at expiration of the second interval.

16. (canceled)

17. The power adapter of claim 16, in which the control circuit is configured to turn on the power transistor responsive to the clamp transistor being turned off at expiration of the second interval.

18. The power adapter of claim 15, including:
a clamp capacitor having a first terminal connected to the drain terminal of the clamp transistor, and having a second terminal;
a diode having an anode connected to a second terminal of the clamp capacitor, and having a cathode; and
an offset capacitor having:
a first terminal connected to the cathode of the diode and to the primary winding; and
a second terminal connected to an input power source.

19. The power adapter of claim 15, including:
a clamp capacitor having a first terminal connected to the drain terminal of the clamp transistor;
a diode having an anode connected to a second terminal of the clamp capacitor and having a cathode; and
an offset capacitor having:
a first terminal connected to the cathode of the diode and to an input voltage source; and
a second terminal connected to ground.

20. The power adapter of claim 15, in which the controller is configured to:
monitor voltage at the drain terminal of the power transistor; and
turn on the clamp transistor responsive to an increase in the voltage at the drain terminal of the power transistor.

21. A process of operating an active clamp flyback converter comprising:
(a) turning on a power transistor to induce current flow in a primary winding of a transformer to store energy in a magnetic field in the transformer;
(b) turning off the power transistor to collapse the magnetic field;
(c) storing energy from the collapsing magnetic field on an offset capacitor; and
(d) transferring the energy stored on the offset capacitor to the primary winding by again turning on the power transistor.

22. The process of claim 21 in which the turning on the power transistor includes causing current to flow from a voltage source through the offset capacitor, a diode, the primary winding, and the power transistor.

23. The process of claim 21 in which the turning off the power transistor includes turning off the power transistor when the current flowing in the power transistor reaches a predetermined value or the power transistor has been turned on for a predetermined time.

24. The process of claim 21 in which the storing energy includes turning on a clamp transistor and causing current to flow from the transformer through the clamp transistor, a clamp capacitor, and a diode to the offset capacitor.

25. The process of claim 21 in which the storing energy includes turning on a clamp transistor coupled to the primary winding when a voltage at a source terminal of the clamp transistor exceeds a voltage at a drain terminal of the clamp transistor.

26. The process of claim 21 in which the transferring includes causing current to flow from a voltage source through the offset capacitor, a diode, the primary winding, and the power transistor.
